(19) United States
(12) Patent Application Publication
(10) Pub. No.: US 2019/0100364 A1
(43) Pub. Date: Apr. 4, 2019

(54) CHILD SAFE CONTAINER

(71) Applicant: Robert Bolen, Bethesda, MD (US)

(72) Inventor: Robert Bolen, Bethesda, MD (US)

(21) Appl. No.: 16/152,322

(22) Filed: Oct. 4, 2018

Related U.S. Application Data
(60) Provisional application No. 62/568,016, filed on Oct. 4, 2017.

(51) Int. Cl. B65D 55/14; B65D 8/00; B65D 51/24; A61J 1/03

(52) U.S. Cl. CPC B65D 55/145; A61J 1/03; B65D 51/245; B65D 11/02

(57) ABSTRACT

A child safe container. The container may be locked by a combination lock. The container may have a hollow foundation with polygonal walls attached to a hollow cylinder extending upward from the base. The container may have a plurality of number disks circling the hollow cylinder, each with polygonal outer wall and two internal ridges forming opposing slots aligned to on face. The container may also have a cap with two prongs with teeth that interact with the internal ridges of the number disks to lock the container, and freely pass through the slots when the container is unlocked. The container may be held together by one-way snaps, that allow free rotation of the number disk, and cap.

### RELATED APPLICATIONS

This application is a utility of and claims priority to provisional application No. 62/568,016 filed Oct. 4, 2017 entitled “Child Proof Locking Mechanism for a Medicine Bottle. The entirety of the above listed application is hereby incorporated herein by reference.

### FIELD OF THE DISCLOSURE

The present disclosure relates to the prescription medicine storage containers. More particularly this disclosure relates to the design of child safe containers for medicine storage.

### BACKGROUND

Unintentional child poisoning represents an increasingly important health issue worldwide, partially because of an increase in the use of drugs and food supplements. Although child-resistant bottle caps have probably saved many lives, they are not foolproof and often involve locking mechanisms that are difficult for seniors easily to use. Many child safe containers involve locking mechanisms that require the cap to be pressed into the bottle to release the lock and allow the cap to be unscrewed. The amount of force required is at times too much for senior citizen to produce. The smooth surface and shape of the bottle often makes gripping the bottle difficult increasing the likely hood the cap will not come off. The very old or people suffering from nerve damage or diseases like Parkinson's may not have the hand control needed to open such containers.

In addition, child-resistant bottle caps do not stop teenagers who know how to open child-resistant bottles. Teen drug abuse and addiction often starts with prescription medicines taken from family medicine cabinets. There remains a need for a child-resistant container that is easily assembled, and easy for seniors to use, and can protect against pilfering.

### SUMMARY

A lockable container having a storage compartment comprising a bottom and an oppositely disposed top edge, the top edge having one of a plurality of attachment snaps or an attachment lip. The container may also have a plurality of rotatable rings with an outer surface and inner surface, each of the plurality of rings may include a plurality of ring attachment snaps and an oppositely disposed attachment lip, a lock ledge extending from the inner surface, the lock ledge extending radially inward more than the attachments lip, and a cap. The cap may include a plurality of teeth arranged in a column and positioned upon at least one prong extending vertically from the cap; and may as well include indicia on an outside cap surface indicating the circumferential position of the at least one prong. Each of the plurality of rotatable rings are circumferentially divided into a plurality of segments. At least one of the plurality of segments includes the lock ledge and another of the plurality of segments does not include the lock ledge; and each of the plurality of segments include distinct indicia distinguishing the segment from each of the other of the plurality of segments. The plurality of rotating rings and storage compartment are connected to one another via the attachment lips and attachment snaps. In a locked configuration at least one of the plurality of teeth on the at least one prong engages with at least one of the lock ledges on one of the plurality of rotatable rings, and in an unlocked configuration, the plurality of teeth align with the plurality of segments that do not include the lock ledge.

In one embodiment the storage compartment, cap and plurality of rotatable rings are may be in the shape of a polygon. In another the plurality of rotatable rings are in the shape of a cylinder. In one more embodiment the storage compartment may further include an inner compartment extending from the bottom and beyond the plurality of ring attachment tabs.

In other embodiments each of the plurality of ring attachments snaps may have a vertically extending arm with a hook extending radially outward from the arm. In some embodiments the distinct indicia may be selected from numbers to symbols, letters, colors, protrusions, indentations, contour and textures, etc. In other embodiments the indicia may be selected from numbers to symbols, letters, colors, protrusions, indentations, contour and textures. In another embodiment the plurality of rotatable rings may be rotatable with respect to one another and with respect to the storage compartment. With some embodiments, while in the locked configuration, the cap may be rotatable with respect to the rotatable rings and the storage compartment.

In other embodiments the at least one prong may be flexible. In many embodiments the storage compartment, plurality of rotatable rings and cap may be constructed from plastic. In yet another embodiment the inner compartment may divided into a plurality of small compartments. In yet another embodiment the cap may further include indication of the plurality of small compartments. In some embodiments the at least one prong may be a cylinder. In yet another embodiment, the plurality of small compartments may further include associated indicia for each compartment. The associated indicia may also be selected from numbers to symbols, letters, colors, protrusions, indentations, contour and textures.

### BRIEF DESCRIPTION OF THE DRAWINGS

The following will be apparent from elements of the figures, which are provided for illustrative purposes.

FIG. 1 depicts an isometric view of an embodiment of the child safe container while locked.

FIG. 2 depicts an isometric view of the child safe container while unlocked and open.

FIG. 3 depicts an exploded view of an embodiment of the child safe container.

FIG. 4a depicts an isometric views of the number disk.

FIG. 4b depicts a cross section of a number disk.

FIG. 5 depicts and isometric views of the base in accordance with an embodiment of the container.

FIG. 6 depicts and isometric top views of the cap in accordance with an embodiment of the container

FIG. 7 depicts an alternate embodiment of the cap.

FIG. 8 depicts an alternate embodiment of the cap.

FIG. 9 depicts an isometric view of the child safe container stacked.

FIG. 10 depicts an alternate embodiment of the child safe container.

FIG. 11a depicts an isometric view of an alternate embodiment of the child safe container.

FIG. 11b depicts an embodiment of the cap for the embodiment of FIG. 11a.

The present application discloses illustrative (i.e., example) embodiments. The claimed inventions are not limited to the illustrative embodiments. Therefore, many implementations of the claims will be different than the illustrative embodiments. Various modifications can be made to the claimed inventions without departing from the spirit and scope of the disclose. The claims are intended to cover implementations with such modifications.

### DETAILED DESCRIPTION

For the purposes of promoting an understanding of the principles of the disclosure, reference will now be made to a number of illustrative embodiments in the drawings and specific language will be used to describe the same.

The present disclosure is directed to systems and methods for providing child safe combination lock container for prescription medicine.

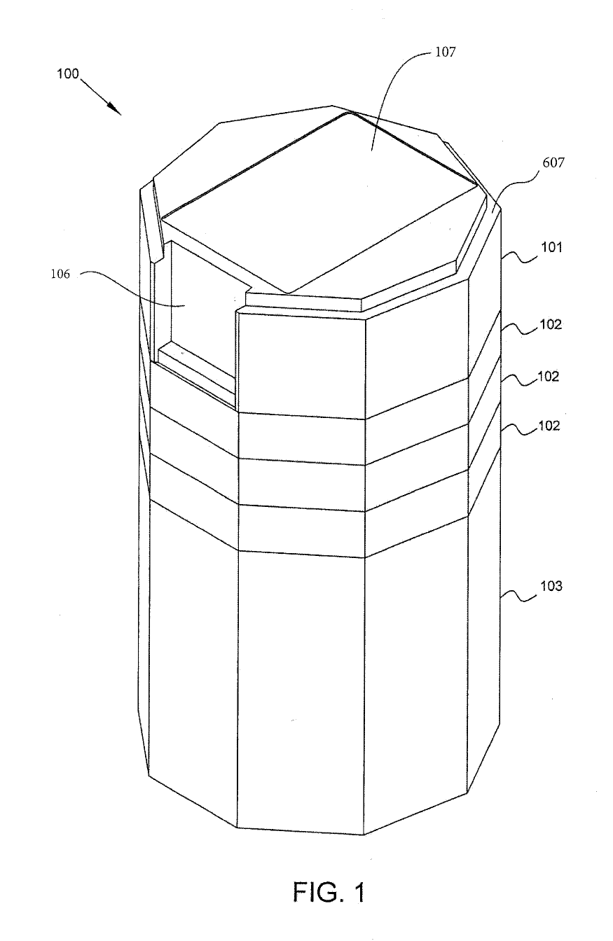

FIG. 1 shows an embodiment of the child safe container 100 when locked. The container is a combination lock that when misaligned will prevent access to its contents. The base 103 may hold a medicine bottle or medicine itself. The outer surface is polygonal depicted with nine sides. A plurality of number disks 102 depicted in FIG. 1 as three stack on top of the base. The number disks also depicted with nine sides. The container nominally has three number disks 102 giving 729 possible combinations. The cap 101, also depicted as nine sided retains an indication 106 on one side denoting the side on which the combination should be input. The cap also has a recessed labeling area 107 on its upper surface. The indication 106 can be but is not limited to an indentation, or a recessed wall (as illustrated), or some unique marking. The container 100 may have all plastic construction.

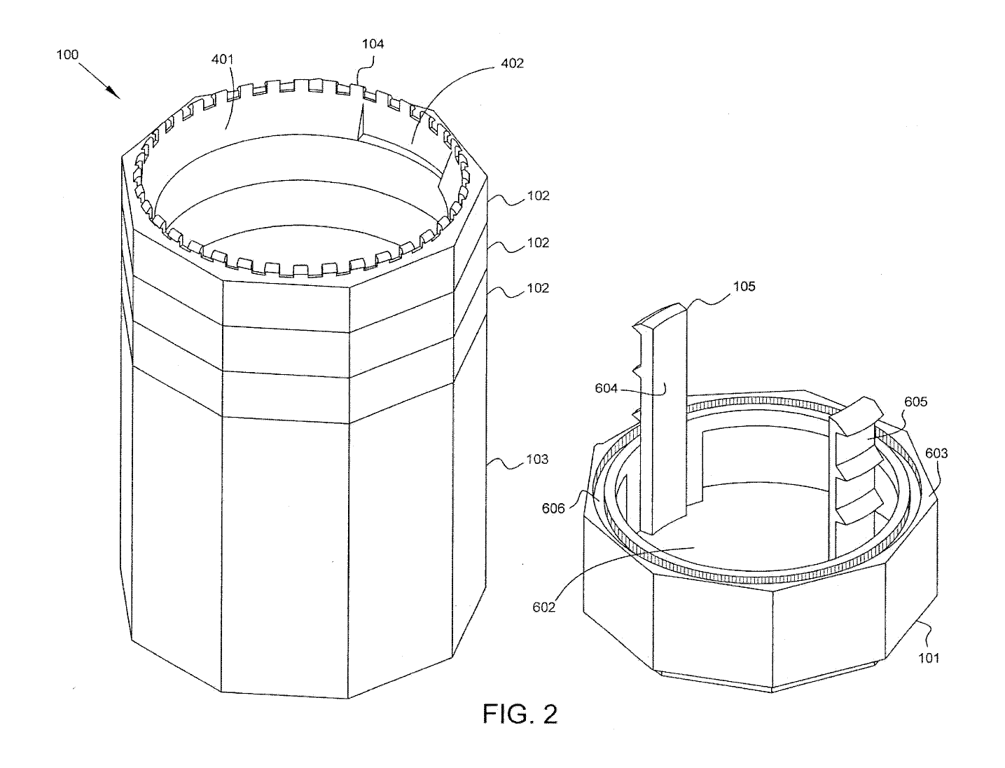

FIG. 2 shows the assembled container unlocked with the top removed. As can be seen each roller may have a plurality of small one-way snaps. The one-way snaps fasten the number disks to each other and maintain the disks 102 coaxial to the center axis of the container 100. The cap has two long embedded multi-tooth prongs. Each tooth grips on to each number disk, locking the container.

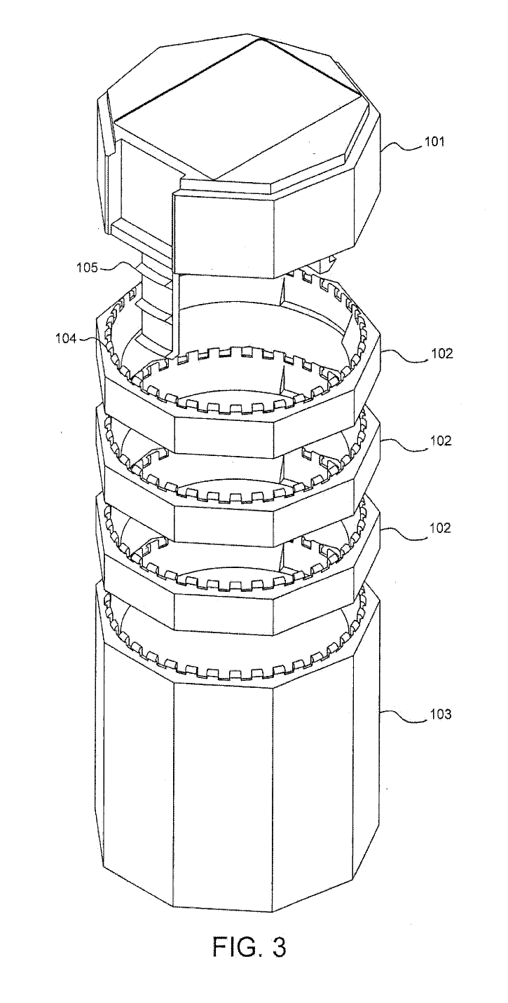

FIG. 3 shows an exploded view of the container 100. As can be seen each of the number disks 102 and the base 103 all have small one-way snaps 104 enabling the container to be assembled with the number disks an any order, producing six combination options to choose from when assembling the container 100.

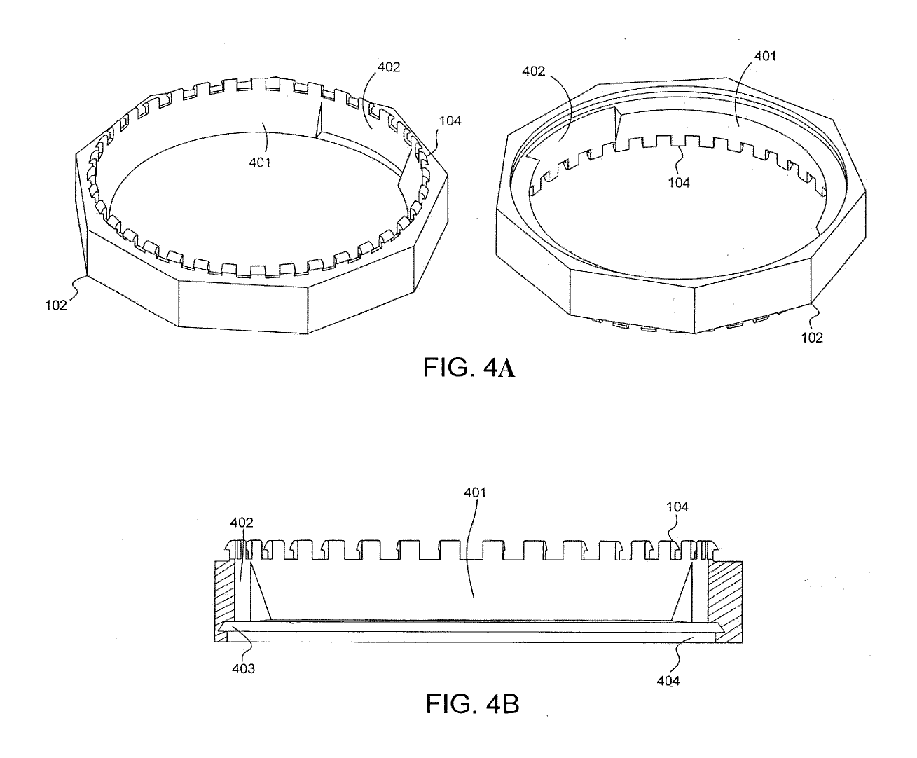

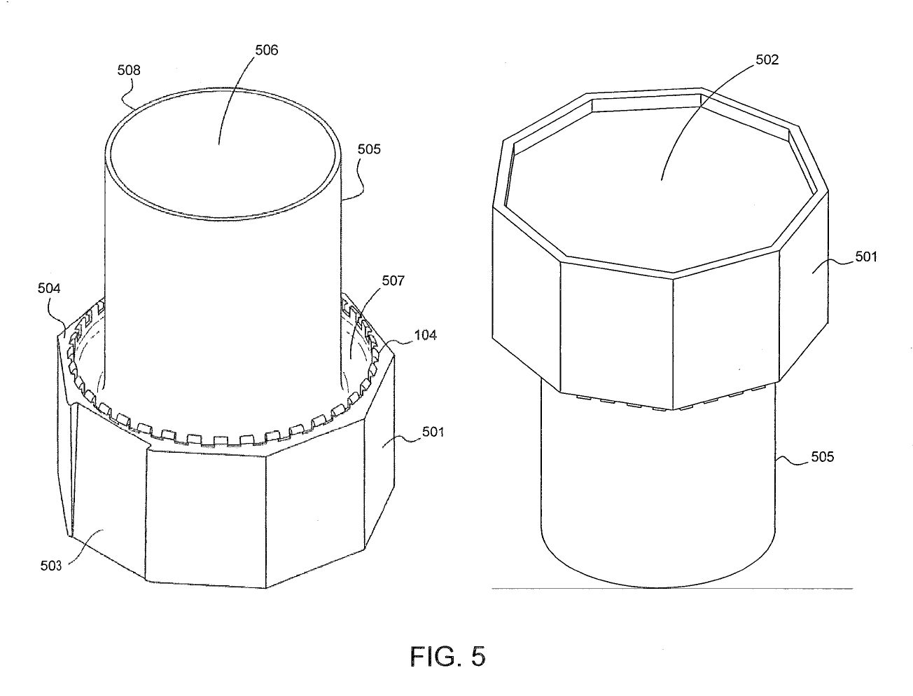

FIG. 4 shows isometric views of a number disk 102. Each number disk 102 contains two large wedged arcs 401. Each arc 401 is flush with the one-way snaps 104 near the top of the number disk and widens as it nears the bottom of the number disk 102. The arc terminates near the bottom of the number disk in a horizontal surface or lip upon which one tooth of each multi-toothed prong will grip. Between the two arcs are two gaps 402 opposite to each other which allows the passage the two multi-tooth prongs 105 when the container 100 is unlocked. Below the arcs 401 is a groove 403 around the inner circumference of the number disk 102. At the base of the groove 403 is a small horizontal lip 404 onto which the small one-way snaps 104 grip. The lip being circumferential allows the number disk 102 to rotate while keeping the disk 102 adjacent and coaxial to the center axis of the container. Though described as number disks 102, the number disks can use numbers letters or symbols that are written, ground, embossed, stamped or stuck on to them. In some embodiments the outer walls of the container 100 are blank allowing the user to make up their own combination.

FIG. 5 shows isometric views of the base 103 of the container. The foundation 501 of the container 100 has short polygonal outer walls. The polygonal walls provide for better grip and appearance. The lower surface 502 of the foundation 501 may be recessed into the foundation 501 providing space to fit the upper surface of the cap 101. The lower surface 502 may have a polygonal rim that extends out from the lower surface. The foundation may have rounded edges, which allows for easier removal of stacked containers.

On the upper surface 504 of the foundation 501 is a ring of small one-way snaps 104 used to connect a number disk 102. A hollow cylinder 505 is connected to the top of the foundation forming an inner cavity 506. This cavity 506 extends into the foundation 501. The portion of the cavity 506 within the foundation 501 may be wider than the hollow cylinder 505. The diameter of the cavity 506 may not change. The hollow cylinder 505 may be a separate piece of the installed in the base, or it be part of the base.

At the base 103 of the hollow cylinder 505 is a recess 507 which provides space for the end of the multi-tooth prong 105. The hollow cylinder 505 is thin walled and may enough clearance between the wedged arcs 401 of the number disk 102 and it to allow one-way passage of the multi-tooth prongs 105 of the cap 101 when closing the container 100. There may be just enough clearance to allow for cap rotation but prevent installation of the cap 101 unless the number disks 102 are in their respective unlock positions. The cap 101 through interaction with multi-tooth prongs 105 may provide some structural support to maintain the number disks coaxial with the center axis of the container. The hollow cylinder's upper edge 508 may rest near flush with the ceiling 602 of the cap.

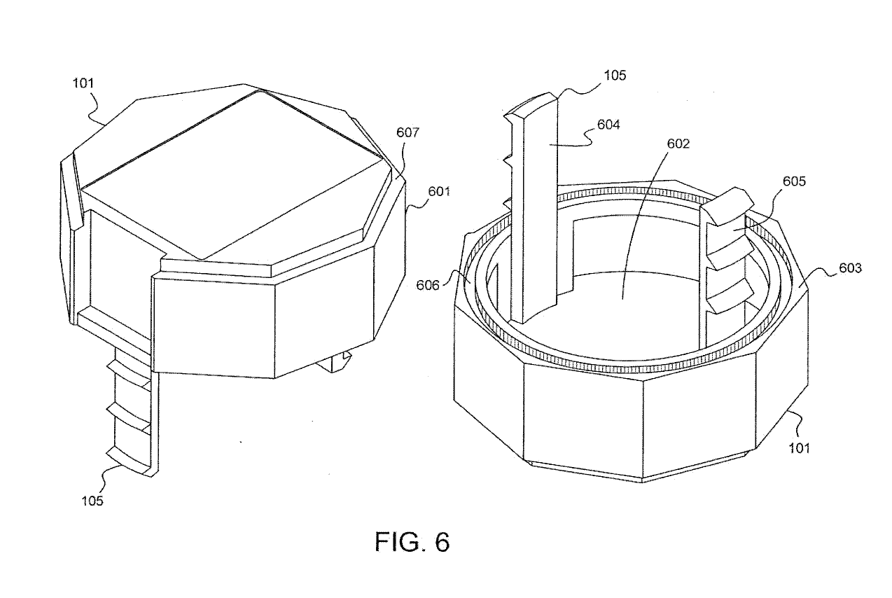

FIG. 6 are isometric views of the cap. It has polygonal outer walls 601. One face 608 may to denote the location of the multi-tooth prongs 105. One of the prongs 105 may be aligned with this wall face 608. The cap 101 may have a recess its underside deep enough to ensure the cap ceiling 602 is nearly flush with the upper edge of the base when assembled. The cap 101 has a lower edge 603 that sits substantially flush with the upper edge of the adjacent number disk. The multi-tooth prongs 105 extend out from the cap ceiling 602 and are substantially the length of a number stacked number disks 102 when measure from the lower edge 603 to the prong end. Although depicted as three the number of teeth and length of prong is based on the amount of number disks used by the container 100, and can be more than three in some embodiments, as long as the number of teeth matches the number of disks and each disk 102 is engaged by at least one tooth.

Each prong has a curved interior wall 604 and exterior wall 605. The interior wall 604 has a small clearance between the interior wall 604 and the hollow cylinder. The exterior wall 605 has a small clearance between the wedge arc of the number disks 102 and itself. The lower surface 603 of the cap has a small recessed slot 606 in line with the one-way snaps 104 of the number disk 102. The slot lacks a horizontal lip, and allows free rotation of the disk while providing support to maintain the cap 101 coaxial to the center axis of the container, and allowing the easy removal of the cap when the cap is unlocked.

The upper surface of the cap may include a recessed edge running around the cap, enabling the upper surface of the cap 101 to fit with the recessed lower surface of the base. The upper surface of the cap may include a thin recess in which the polygonal rim of the base 103 may fit. The cap may include rounded edges on the upper surface for better appearance, easier removal of stacked containers 100, and reduced grip if trying to break open a locked container. As the cap is free spinning the user need not scramble the number disks to lock the cap 101 but instead merely twist the cap.

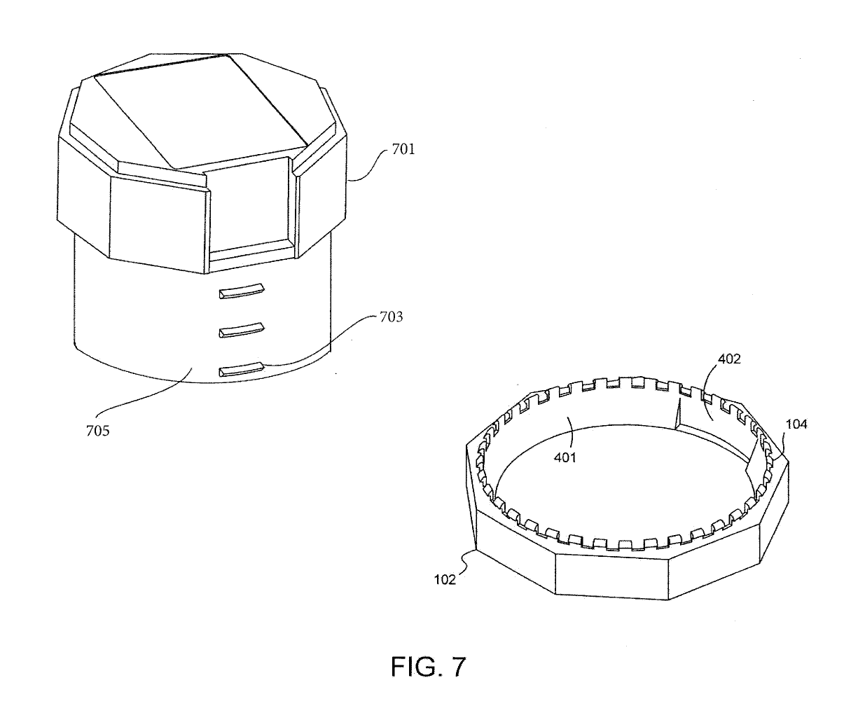

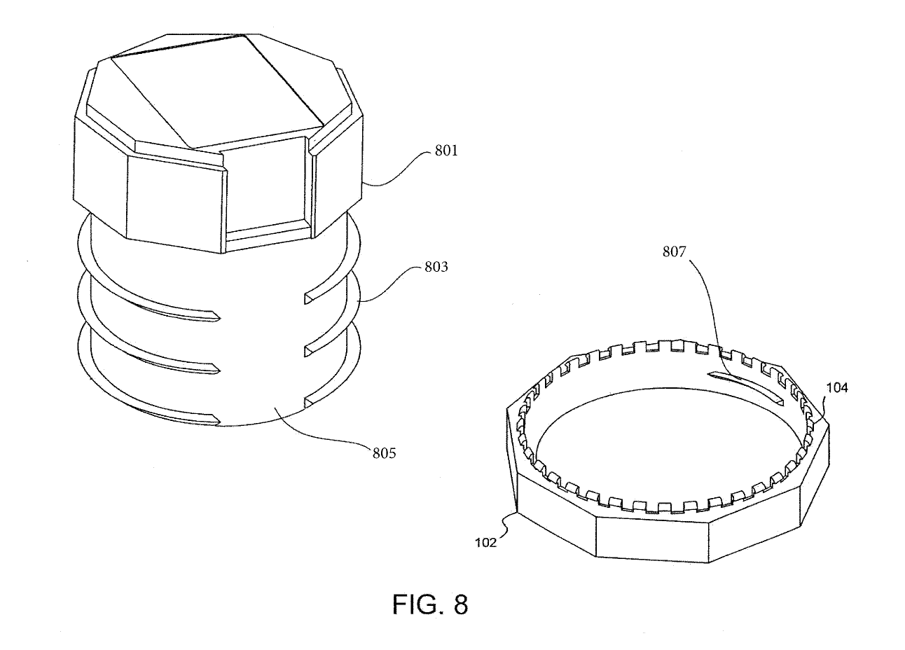

Other embodiments of the container can include a modified cap, made up of a hollow cylinder with slot corresponding to a specific arrangement of the number disk which may have pegs or snaps corresponding to each slot. Another embodiment as illustrated in FIG. 8 may include a cap 801 made up of a hollow cylinder 805 with near circumferential lips 803 with gaps in line with each other and number disks with a tooth 807 that may slide through the gap when the container is unlocked. One embodiment may, as shown in FIG. 7, include a cap 701 made up of a hollow cylinder 705 with teeth 703 in line with each other to replace the multi-tooth prongs. Other embodiment may involve rectangular arcs and teeth instead of wedged arcs and teeth.

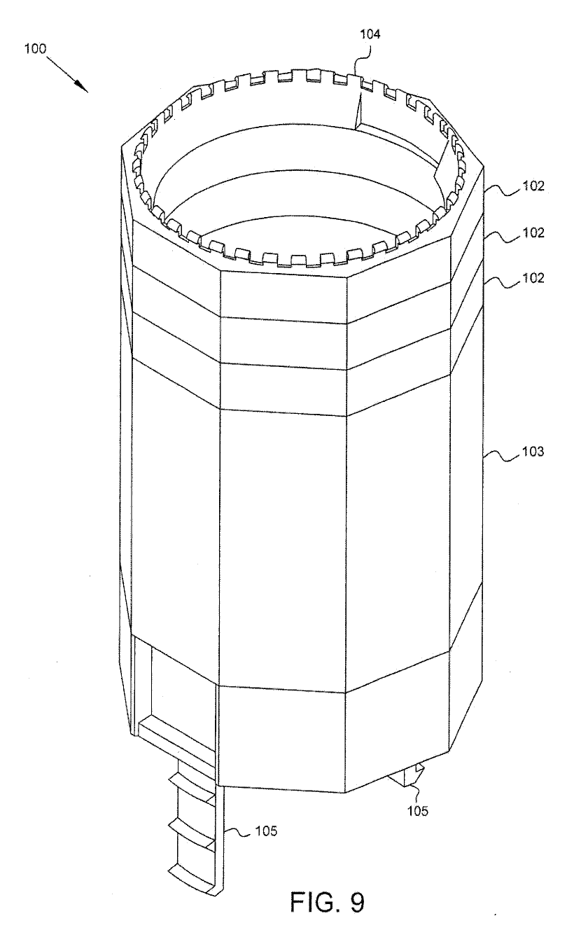

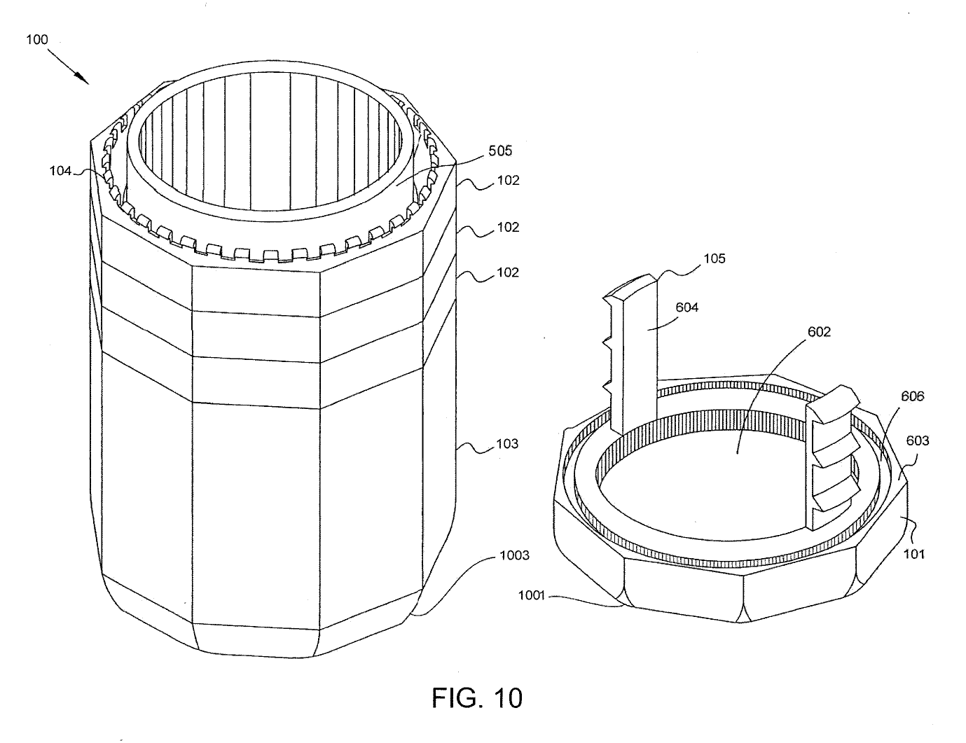

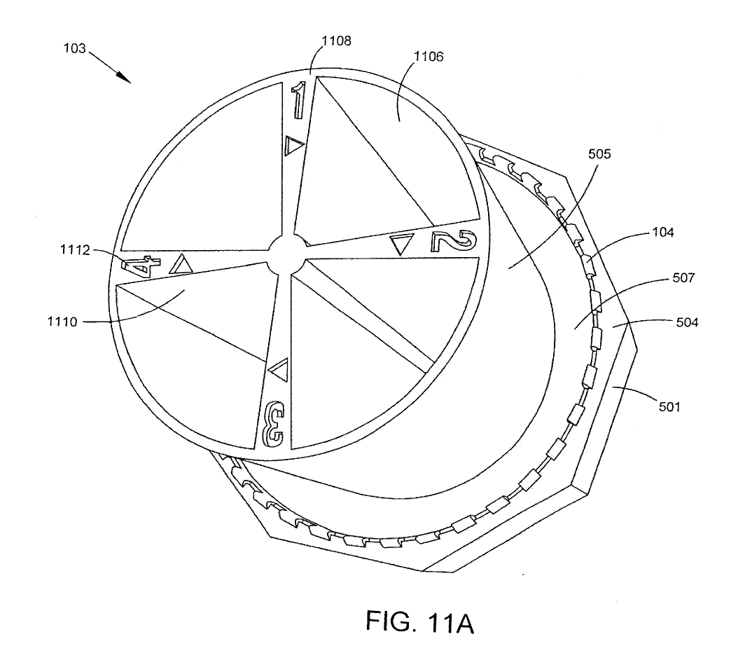

FIG. 9 illustrates the how one embodiment of the container can be stacked end to end. The recessed face provides a grip to handle and remove stacked containers 100. FIG. 10 illustrates an additional embodiment of the container 100 having rounded edges 1001 on the cap and rounded edges 1003 on the base and incorporates the hollow cylinder 505.

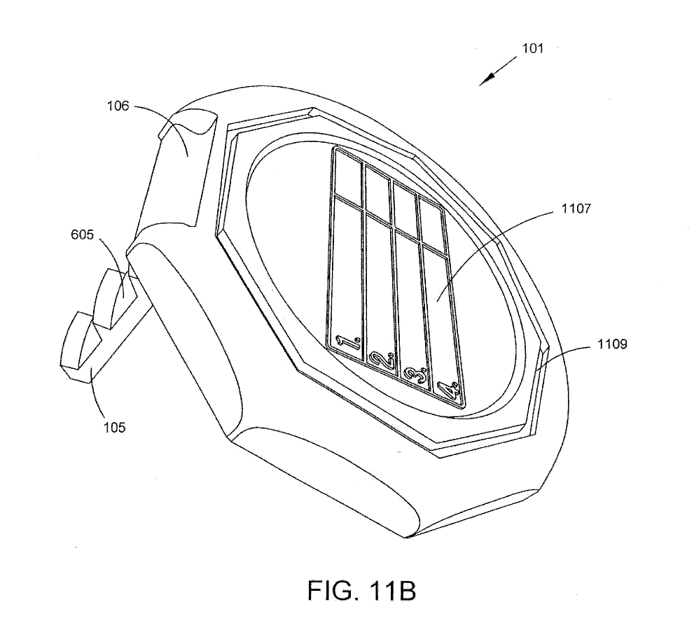

FIG. 11a illustrates another embodiment for storing multiple different medications. The space within the hollow cylinder 505 is split into a number compartments 1106 by multiple radial walls 1110 connected at the center axis of the base 103. The top surface 1108 of each wall 1110 has a label 1112 for each compartment. The label may be numbers and symbols as shown or may include letters or just symbols. The labels 1112 may be engraved, as shown, but may also be embossed. The labels may also be place on the sides of the walls. Although four walls 1110 and four compartments 1106 are illustrated, the base may have any number of wall 1110 and associated compartments 1106.

FIG. 11b illustrates the cap 101 associated with the base 103 illustrated in FIG. 11a. As can be seen the cap has a contents label 1107 denoting the contents of each compartment. The contents label 1107 may be engraved, embossed as shown, or may be stickers. The table may be used to display prescription, dosage, frequency of use, expiration date, or purpose of each medication. The cap also has a polygonal grove 1109 to enable stacking.

The child safe container may be made of plastic. Other embodiments may be made of acrylics, polycarbonates, acetal, micarta, polyterafluoroethylene, PTFE. In some embodiments some portion of the container maybe made of other materials, such as glass, ceramics and or metals.

Although examples are illustrated and described herein, embodiments are nevertheless not limited to the details shown, since various modifications and structural changes may be made therein by those of ordinary skill within the scope and range of equivalents of the claims.

What is claimed is:

1. A lockable container comprising:
a storage compartment comprising a bottom and an oppositely disposed top edge, the top edge having one of a plurality of attachment snaps or an attachment lip;
a plurality of rotatable rings with an outer surface and inner surface, each of the plurality of rings comprising:
a plurality of ring attachment snaps and an oppositely disposed attachment lip,
a lock ledge extending from the inner surface, the lock ledge extending radially inward more than the attachments lip,
a cap, the cap including a plurality of teeth arranged in a column and positioned upon at least one prong extending vertically from the cap; the cap including indicia on an outside cap surface indicating the circumferential position of the at least one prong;
wherein each of the plurality of rotatable rings are circumferentially divided into a plurality of segments, wherein at least one of the plurality of segments includes the lock ledge and another of the plurality of segments does not include the lock ledge; and each of the plurality of segments include distinct indicia distinguishing the segment from each of the other of the plurality of segments;
wherein the plurality of rotating rings and storage compartment are connected to one another via the attachment lips and attachment snaps; and wherein in a locked configuration at least one of the plurality of teeth on the at least one prong engages with at least one of the lock ledges on one of the plurality of rotatable rings, and in an unlocked configuration, the plurality of teeth align with the plurality of segments that do not include the lock ledge.

2. The lockable container of claim 1, wherein the storage compartment, cap and plurality of rotatable rings are in the shape of a polygon.

3. The lockable container of claim 1, wherein the plurality of rotatable rings are in the shape of a cylinder.

4. The lockable container of claim 1, wherein the storage compartment further comprises an inner compartment extending from the bottom and beyond the plurality of ring attachment tabs.

5. The lockable container of claim 1, each of the plurality of ring attachments snaps have a vertically extending arm with a hook extending radially outward from the arm.

6. The lockable container of claim 1, wherein the distinct indicia is selected from the group of numbers, symbols, letter, colors, protrusions, indentations, contour and textures.

7. The lockable container of claim 1, wherein the indicia is selected from the group of numbers, symbols, letter, colors, protrusions, indentations, contour and textures.

8. The lockable container of claim 1, wherein the plurality of rotatable rings are rotatable with respect to one another and with respect to the storage compartment.

9. The lockable container of claim 1, wherein in the locked configuration, the cap is rotatable with respect to the rotatable rings and the storage compartment.

10. The lockable container of claim 1, wherein the at least one prong is flexible.

11. The lockable container of claim 1, wherein the storage compartment, plurality of rotatable rings and cap are constructed from plastic.

12. The lockable container of claim 4, wherein the inner compartment is divided into a plurality of small compartments.

13. The lockable container of claim 12, wherein the cap further comprises indicia corresponding to the plurality of small compartments.

14. The lockable container of claim 1, wherein the at least one prong is a cylinder.

15. The lockable container of claim 13, wherein the plurality of small compartments further comprise associated indicia for each compartment.

16. The lockable container of claim 15, wherein the associated indicia are selected from the group of numbers, symbols, letter, colors, protrusions, indentations, contour and textures.
